(19) United States
(12) Patent Application Publication
(10) Pub. No.: US 2025/0349871 A1
(43) Pub. Date: Nov. 13, 2025

(54) FUEL CELL SYSTEM

(71) Applicant: TOYOTA JIDOSHA KABUSHIKI KAISHA, Toyota-shi (JP)

(72) Inventors: Yusuke MIYAMOTO, Nisshin-shi (JP); Nobukazu MIZUNO, Nagakute-shi (JP); Kosuke UEDA, Toyota-shi (JP)

(73) Assignee: TOYOTA JIDOSHA KABUSHIKI KAISHA, Toyota-shi (JP)

(21) Appl. No.: 19/014,982

(22) Filed: Jan. 9, 2025

(30) Foreign Application Priority Data
May 9, 2024 (JP) 2024-076227

(51) Int. Cl. H01M 8/04746; H01M 8/04111; H01M 8/0438

(52) U.S. Cl. CPC H01M 8/04776; H01M 8/04111; H01M 8/04395; H01M 8/0441; H01M 8/04425; H01M 8/04432; H01M 8/04753; H01M 8/04761; H01M 8/04783

(57) ABSTRACT

A fuel cell system includes a system intake unit, a system exhaust unit, a fuel cell stack, an atmospheric pressure sensor, an air compressor, an airflow meter, a pressure sensor, and a control device, and prior to power generation, the air compressor is operated in a state in which an intake pipe and an exhaust pipe are connected, an exhaust pipe pressure loss map and an intake pipe pressure loss map are generated, and in power generation, an exhaust pipe pressure loss and an intake pipe pressure loss are determined by referring to the exhaust pipe pressure loss map and the intake pipe pressure loss map based on a target value of a stack flow rate, and the air compressor is controlled by a determined rotational speed for realizing the target value at the pressure ratio of the inlet pressure and the outlet pressure.

### CROSS-REFERENCE TO RELATED APPLICATION

This application claims priority to Japanese Patent Application No. 2024-076227 filed on May 9, 2024, incorporated herein by reference in its entirety.

### BACKGROUND

### 1. Technical Field

The present disclosure relates to a fuel cell system.

### 2. Description of Related Art

As described in Japanese Unexamined Patent Application Publication No. 2020-126792 (JP 2020-126792 A), an intake line including an intake pipe for supplying cathode gas to a fuel cell stack and an exhaust line including an exhaust pipe for discharging cathode gas from the fuel cell stack are connected to a fuel cell system. The fuel cell system includes an air compressor that supplies the cathode gas to the fuel cell stack, and an intercooler that adjusts the temperature of the cathode gas. An outlet of the intercooler leads to an inlet of a cathode flow path of the fuel cell stack. That is, the cathode gas is supplied to the fuel cell stack via the intake line and the intercooler by the intake of the cathode gas by the air compressor.

JP 2020-126792 A describes that the pressure at the outlet of the intercooler is affected by pressure loss at the intake line or from the intake line to the intercooler. The pressure loss depends on the length of the pipe, the shape of the pipe, and the coefficient of friction of the inner surface of the pipe. Therefore, the specifications of the pipes of the intake line and the exhaust line affect the amount of the cathode gas flowing through the fuel cell stack and the amount of the cathode gas discharged from the fuel cell stack.

### SUMMARY

The inventors have developed a fuel cell system including a fuel cell stack, an air compressor, a control device, and the like. The fuel cell system of the inventors does not include an intake line and an exhaust line, and can be used universally. More specifically, an intake line and an exhaust line corresponding to a passenger car, a truck, a ship, a stationary power generation facility, or the like can be connected to the fuel cell system of the inventors. In the fuel cell system of the inventors, a fixed value is used for the pressure loss at the intake line and the exhaust line.

However, the specifications of the pipes differ depending on products including the fuel cell system. Therefore, the pressure loss at the intake line and the exhaust line also varies. Therefore, there is a difference between actual pressure loss and design pressure loss that is a fixed value. Thus, there is a problem that the flow rate of the cathode gas cannot be controlled accurately.

The present disclosure can be implemented in the following aspects.

According to one aspect of the present disclosure, a fuel cell system is provided.

The fuel cell system includes:
a system intake unit through which cathode gas to be supplied to the fuel cell system flows and to which an intake pipe having an intake pipe pressure loss is connected;
a system exhaust unit through which the cathode gas discharged from the fuel cell system flows and to which an exhaust pipe having an exhaust pipe pressure loss is connected;
a fuel cell stack configured to generate electric power using the cathode gas supplied via the system intake unit and discharge the cathode gas used for power generation via the system exhaust unit;
an atmospheric pressure sensor configured to acquire an atmospheric pressure;
an air compressor configured to compress the cathode gas flowing through the system intake unit and discharge the cathode gas to the fuel cell stack;
an airflow meter configured to acquire an airflow meter flow rate that is a flow rate of the cathode gas to be sucked into the air compressor;
a pressure sensor configured to acquire an outlet pressure that is a pressure on an outlet side of the air compressor; and
a control device configured to control the fuel cell system.
   The control device is configured to:
prior to the power generation in the fuel cell system, operate the air compressor at a plurality of different airflow meter flow rates in a state in which the intake pipe and the exhaust pipe are connected to the fuel cell system;
create an exhaust pipe pressure loss map associated with the airflow meter flow rate based on a difference between the atmospheric pressure as a pressure of the cathode gas at an outlet of the exhaust pipe and the outlet pressure;
create an intake pipe pressure loss map associated with the airflow meter flow rate based on a difference between a calculated value of an inlet pressure that is a pressure on an inlet side of the air compressor and determined based on the outlet pressure and a rotation speed of the air compressor and the atmospheric pressure as a pressure of the cathode gas at an inlet of the intake pipe;
in the power generation in the fuel cell system,
determine, based on a target value of a stack flow rate of supply to the fuel cell stack for realizing a target current, the exhaust pipe pressure loss at the target value and the intake pipe pressure loss at the target value by referring to the exhaust pipe pressure loss map and the intake pipe pressure loss map; and
determine a rotation speed for realizing the target value at a pressure ratio between the inlet pressure determined based on a difference between the atmospheric pressure and the intake pipe pressure loss at the target value and the outlet pressure determined based on a sum of the atmospheric pressure and the exhaust pipe pressure loss at the target value, and control the air compressor based on the determined rotation speed.
   The fuel cell system is mounted on various products such as a passenger car, a truck, a ship, and a stationary power generation facility. The exhaust pipe pressure loss and the intake pipe pressure loss differ depending on the products including the fuel cell system. With this configuration, the fuel cell system determines the intake pipe pressure loss map and the exhaust pipe pressure loss map before the power generation is performed. Thus, the fuel cell system can control the rotation speed of the air compressor in consideration of the intake pipe pressure loss and the exhaust pipe pressure loss at the time of power generation. Therefore, in the fuel cell system, the flow rate of the cathode gas flowing through the fuel cell stack can be controlled more accurately than in the case where a fixed pressure loss is used regardless of the specifications of the intake pipe and the exhaust pipe.
   The fuel cell system according to the above aspect may further include:
a first valve provided on an inlet side of the fuel cell stack and configured to change the flow rate of the cathode gas to be supplied to the fuel cell stack;
a second valve provided on an outlet side of the fuel cell stack and configured to change the flow rate of the cathode gas discharged from the fuel cell stack;
a bypass pipe connecting an inlet side of the first valve and an outlet side of the second valve; and
a third valve configured to change the flow rate of the cathode gas flowing through the bypass pipe.
   The control device may be configured to
create the intake pipe pressure loss map and the exhaust pipe pressure loss map in a state in which the first valve and the second valve are closed and the third valve is open.
   With this configuration, the cathode gas does not flow to the fuel cell stack when determining the intake pipe pressure loss map and the exhaust pipe pressure loss map. That is, the fuel cell system can more accurately determine the pressure losses in the intake pipe and the exhaust pipe by excluding the pressure loss in the fuel cell stack.
   In the fuel cell system according to the above aspect,
the air compressor may further include
a bearing intake pipe through which part of the cathode gas discharged by the air compressor flows to a bearing of the air compressor and that has a bearing intake pipe pressure loss as a pressure loss, and
a bearing exhaust pipe through which the cathode gas having flowed through the bearing flows to the system exhaust unit and that has a bearing exhaust pipe pressure loss as the pressure loss.
   The control device may be configured to
prior to the power generation in the fuel cell system and in a state in which the air compressor is operating, create a flow rate map of the stack flow rate associated with the airflow meter flow rate based on the intake pipe pressure loss, the exhaust pipe pressure loss, the bearing exhaust pipe pressure loss, the bearing intake pipe pressure loss, and a pressure loss of the fuel cell system, and
in the power generation in the fuel cell system, determine the exhaust pipe pressure loss and the intake pipe pressure loss based on the target value and the flow rate map.
   In such a configuration, the fuel cell system causes the cathode gas to flow through the bearing of the air compressor. The temperature of the bearing of the air compressor increases due to rotation of a motor during the operation of the air compressor. As a result, the characteristics of the air compressor change due to fusing of a shaft and the bearing. Therefore, the flow rate of the cathode gas may deviate from an ideal value even if the control device performs control by referring to the intake pipe pressure loss map and the exhaust pipe pressure loss map determined in advance. The fuel cell system cools the bearing by causing the cathode gas to flow through the bearing of the air compressor. Therefore, in the fuel cell system, the flow rate of the cathode gas flowing through the fuel cell stack can be controlled more accurately than in the case where the bearing is not cooled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a schematic configuration of a fuel cell system according to a first embodiment;

FIG. 2 is an explanatory diagram illustrating characteristics of an air compressor;

FIG. 3 is a block diagram illustrating a configuration of a control device;

FIG. 4 is a flowchart illustrating a method of setting a fuel cell system;

FIG. 5 is an explanatory diagram showing a pressure-loss map; and

FIG. 6 is a flowchart illustrating a method of determining a map.

### DETAILED DESCRIPTION OF EMBODIMENTS

### A. First Embodiment

### A-1. Configuring System:

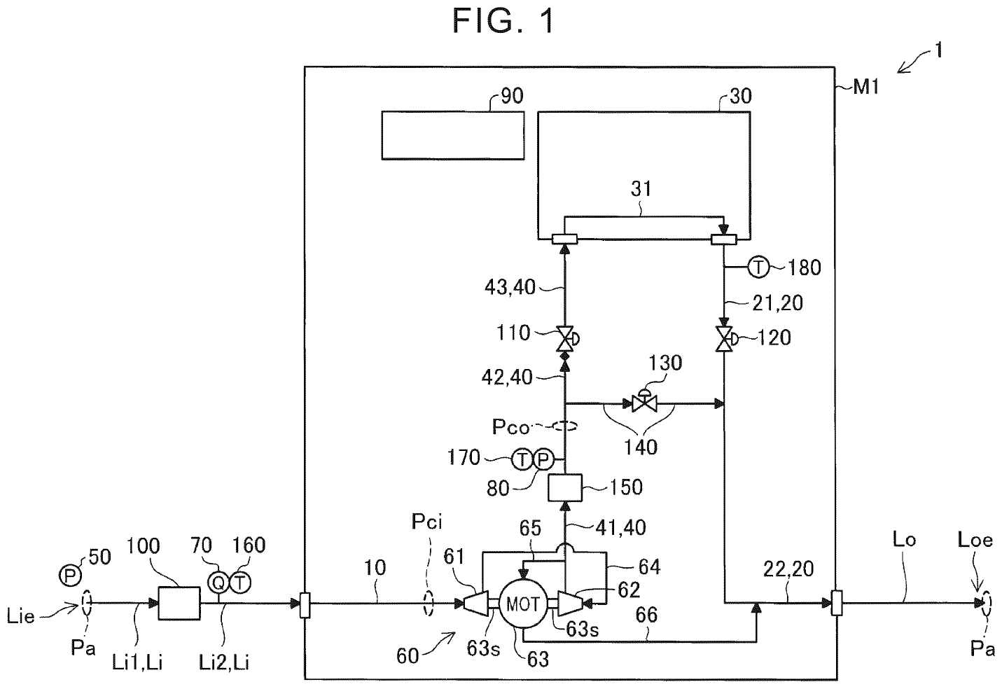

FIG. 1 is an explanatory diagram illustrating a schematic configuration of a fuel cell system 1 according to a first embodiment. The fuel cell system 1 is mounted, for example, as a power source in a passenger car, a truck, a ship, a stationary power generation facility, or the like. The fuel cell system 1 is connected to an intake pipe Li and an exhaust pipe Lo of a product mounted on the fuel cell system 1 in order to receive a supply of cathode gases required for power generation. In FIG. 1, a solid line having an arrow indicates a pipe. The arrow indicates the flow direction of the cathode gas. That is, the intake pipe Li in the lower left portion of FIG. 1 is upstream, and the exhaust pipe Lo in the lower right portion of FIG. 1 is downstream.

The intake pipe Li allows the cathode gases supplied to the fuel cell system 1 to flow therethrough (see the lower left portion of FIG. 1). More specifically, the intake pipe Li is a pipe connecting the fuel cell system 1 and the atmosphere outside the product in which the fuel cell system 1 is mounted. That is, the pressure at the inlet Lie of the intake pipe Li is Pa atmospheric pressure. The system intake unit 10 to which the intake pipe Li is connected is controlled to be lower than the atmospheric pressure Pa by an air compressor 60 described later. For this reason, the cathode gases are supplied to the fuel cell system 1 through the intake pipe Li.

The intake pipe Li is connected to the system intake unit 10 of the fuel cell system 1 via an air cleaner 100 described later. In this specification, the intake pipe Li located upstream of the air cleaner 100 is referred to as a first intake pipe Li1. An intake pipe Li located downstream of the air cleaner 100 is referred to as a second intake pipe Li2.

The exhaust pipe Lo allows the cathode gases discharged from the fuel cell system 1 to flow therethrough (see the lower right part of FIG. 1). More specifically, the exhaust pipe Lo is connected to the system exhaust unit 20 of the fuel cell system 1. That is, the exhaust pipe Lo is a pipe connecting the fuel cell system 1 and the atmosphere outside the product in which the fuel cell system 1 is mounted. That is, the pressure at the outlet Loe of the exhaust pipe Lo is Pa atmospheric pressure. The pressure of the system exhaust unit 20 to which the exhaust pipe Lo is connected is controlled to be higher than the atmospheric pressure Pa by the air compressor 60. Therefore, the cathode gas flows through the exhaust pipe Lo and is discharged from the fuel cell system 1.

Li of the intake pipe and Lo of the exhaust pipe differ depending on the type of the fuel cell system 1. Specifications of the intake pipe Li and the exhaust pipe Lo are, specifically, the length of the pipe, the shape of the pipe, the coefficient of friction of the inner surface of the pipe, and the like. In the present specification, the pressure loss in the intake pipe Li is defined as an intake pipe pressure loss Di. The pressure loss in the exhaust pipe Lo is defined as the exhaust pipe pressure loss Do.

The fuel cell system 1 includes a system intake unit 10, a system exhaust unit 20, a fuel cell stack 30, a stack intake unit 40, an atmospheric pressure sensor 50, an air compressor 60, an airflow meter 70, a pressure sensor 80, a control device 90, an air cleaner 100, a first valve 110, a second valve 120, a third valve 130, a bypass pipe 140, an intercooler 150, a first temperature sensor 160, a second temperature sensor 170, and a third temperature sensor 180.

The components of the fuel cell system 1 other than the atmospheric pressure sensor 50, the airflow meter 70, the air cleaner 100, and the first temperature sensor 160 shown in the lower left portion of FIG. 1 are configured as a single module M1 regardless of the positions of the intake pipe Li and the exhaust pipe Lo. Since the atmospheric pressure sensor 50, the airflow meter 70, the air cleaner 100, and the first temperature sensor 160 are arranged in accordance with the positions of the intake pipe Li and the exhaust pipe Lo, they are illustrated away from the module M1.

The fuel cell stack 30 has a configuration in which a plurality of single cells, each of which can be one power generation element, are stacked (see the upper part of FIG. 1). Each unit cell is called a so-called polymer electrolyte fuel cell, and is supplied with hydrogen gas as an anode gas and air as a cathode gas to generate electric power. Each single cell has a membrane electrode assembly in which electrodes are arranged on both surfaces of a polymer electrolyte membrane having ion conductivity, and a pair of separators sandwiching the membrane electrode assembly. An anode flow path (not shown) through which hydrogen gas flows is formed between the membrane electrode assembly and the separator on the anode side. A cathode flow path 31 through which the cathode gas flows is formed between the membrane electrode assembly and the separator on the cathode side. In FIG. 1, only the cathode flow path 31 is shown for ease of understanding of the technology.

In the fuel cell stack 30, the stack intake unit 40 is connected to the inlet of the cathode flow path 31. In the fuel cell stack 30, the system exhaust unit 20 is connected to the outlet of the cathode flow path 31. That is, the fuel cell stack 30 generates electric power using the cathode gas supplied through the stack intake unit 40. In the fuel cell stack 30, the cathode gas used for power generation is discharged through the system exhaust unit 20. Therefore, for the cathode gas, the inlet of the cathode flow path 31 is the inlet side of the fuel cell stack 30, and the outlet of the cathode flow path 31 is the outlet side of the fuel cell stack 30. Herein, the flow rate supplied to the fuel cell stack 30 is defined as a stack flow rate Qs.

The air cleaner 100 removes foreign matter from the cathode gas supplied to the fuel cell system 1. The air cleaner 100 is provided on the intake pipe Li. That is, the air cleaner 100 suppresses foreign matter in the atmosphere from entering the fuel cell system 1 together with the cathode gas.

An intake pipe Li is connected to the system intake unit 10 (see the lower center portion in FIG. 1). The intake pipe Li connected to the system intake unit 10 is a second intake pipe Li2 located further down than the air cleaner 100. That is, the system intake unit 10 is a pipe connecting the second intake pipe Li2 and the air compressor 60. The system intake unit 10 allows the cathode gas purified by the air cleaner 100 to flow to the air compressor 60.

The atmospheric pressure sensor 50 acquires the atmospheric pressure Pa (see the lower left part in FIG. 1). The atmospheric pressure sensor 50 acquires the pressure of the cathode gas at the inlet Lie of the intake pipe Li by acquiring the atmospheric pressure Pa. Further, the atmospheric pressure sensor 50 acquires the pressure of the cathode gas at the outlet Loe of the exhaust pipe Lo by acquiring the atmospheric pressure Pa. That is, the atmospheric pressure sensor 50 acquires the pressure of the cathode gas upstream of the intake pipe Li and downstream of the exhaust pipe Lo. The atmospheric pressure sensor 50 transmits the acquired atmospheric pressure Pa to the control device 90.

The airflow meter 70 acquires an airflow meter flow rate Qi which is a flow rate of the cathode gas sucked into the air compressor 60 (see the lower left part in FIG. 1). The airflow meter 70 is provided in the second intake pipe Li2 between the air cleaner 100 and the system intake unit 10. As shown in FIG. 1, the cathode gas flowing through the system intake unit 10 flows to the air compressor 60. The airflow meter 70 transmits the acquired airflow meter flow rate Qi to the control device 90.

The first temperature sensor 160 acquires the temperature of the cathode gas sucked into the air compressor 60. The first temperature sensor 160 sends the acquired temperature to the control device 90.

The air compressor 60 can compress the cathode gas flowing through the system intake unit 10 and discharge the cathode gas to the fuel cell stack 30 (see the lower middle portion in FIG. 1). Specifically, the air compressor 60 is a two-stage boost type turbocompressor. The air compressor 60 includes a first compressor 61, a second compressor 62, a motor 63, a bearing (not shown), a relay pipe 64, a bearing intake pipe 65, and a bearing exhaust pipe 66.

The first compressor 61 includes a first impeller (not shown) and a first impeller accommodating portion (not shown) accommodating the first impeller. The first impeller is connected to one end of the motor 63 in the rotating shaft 63s, and is rotated by the motor 63. The first impeller accommodation portion is connected to the system intake unit 10 and the relay pipe 64. That is, the first compressor 61 sucks the cathode gas from the system intake unit 10 by the rotation of the first impeller. Further, the first compressor 61 compresses the cathode gas in the first impeller accommodating portion. Moreover, the first compressor 61 discharges the compressed cathode gas to the relay pipe 64.

The second compressor 62 includes a second impeller (not shown) and a second impeller accommodating portion (not shown) that accommodates the second impeller. The second impeller is connected to the other end of the motor 63 in the rotating shaft 63s, and is rotated by the motor 63. The second impeller housing portion is connected to the relay pipe 64 and the stack intake unit 40. That is, the second compressor 62 sucks the cathode gas from the relay pipe 64 by the rotation of the second impeller. Further, the second compressor 62 compresses the cathode gas in the second impeller housing. In addition, the second compressor 62 discharges the compressed cathode gas to the stack intake unit 40.

That is, the cathode gas is sucked from the side of the first compressor 61 and discharged from the side of the second compressor 62. Therefore, for the cathode gas, the inlet of the first compressor 61 is the inlet side of the air compressor 60, and the outlet of the second compressor 62 is the outlet side of the air compressor 60. Herein, the pressure of the cathode gas on the inlet side of the air compressor 60 is defined as the inlet pressure Pci. The pressure of the cathode gases on the outlet side of the air compressor 60 is defined as the outlet pressure Pco. The outlet pressure Pco for the inlet pressure Pci determined by equation (1) is defined as the pressure ratio R.

$$R = Pco / Pci \qquad ( 1 )$$

Note that the outlet pressure Pco is not the pressure at the outlet of the second compressor 62. The outlet pressure Pco is obtained by a pressure sensor 80, which will be described later. In the flow path of the cathode gas, an intercooler 150, a bearing intake pipe 65, and a first stack intake unit 41 are provided between the pressure sensor 80 and the air compressor 60. Therefore, the outlet pressure Pco is a pressure lower than the pressure at the outlet of the second compressor 62 due to the pressure loss caused by the intercooler 150, the bearing intake pipe 65, and the first-stack intake unit 41.

The motor 63 rotates the first impeller and the second impeller. The motor 63 is located between the first impeller and the second impeller, and rotates the first impeller and the second impeller via the rotating shaft 63s. The motor 63 rotates at a rotational speed n per unit time in accordance with a command from the control device 90.

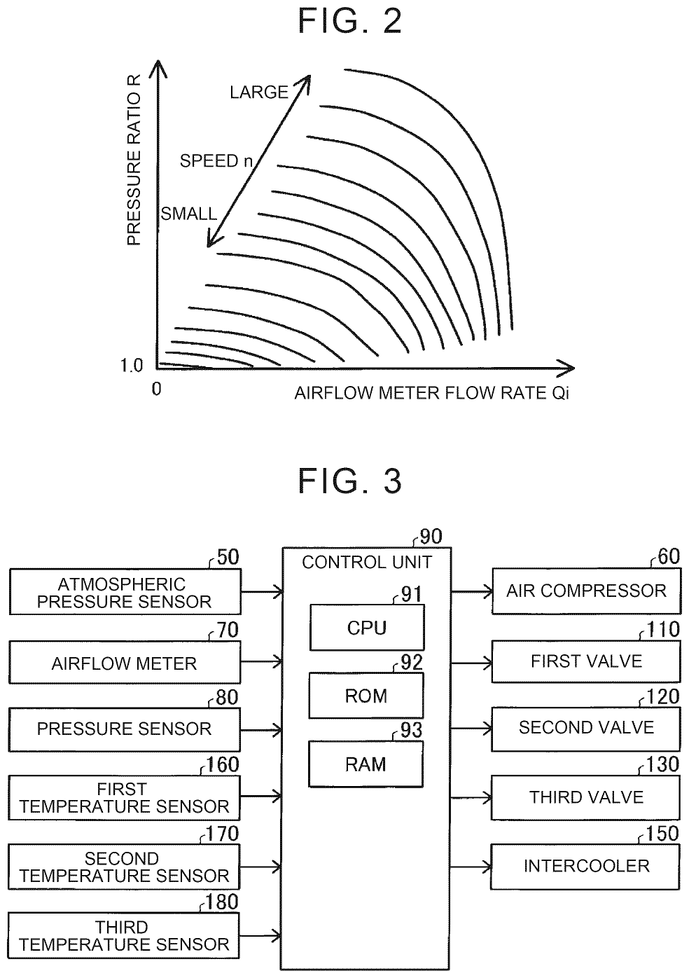

FIG. 2 is an explanatory diagram illustrating characteristics of the air compressor 60. As shown in FIG. 2, the air compressor 60 has a relation between the pressure ratio R, the flow rate Qi of the airflow meter, and the rotational speed n. In other words, the relation between the pressure ratio R and the airflow meter flow rate Qi differs depending on the rotational speed n. The control device 90 described later controls the number of revolutions n based on the characteristics of the air compressor 60.

The bearings rotatably support the rotating shaft 63s of the motor 63. The bearing is in particular an air bearing. A bearing intake pipe 65 and a bearing exhaust pipe 66 are connected to a bearing portion of the air compressor 60 (see a lower center portion in FIG. 1). That is, a part of the cathode gas discharged from the air compressor 60 flows to the bearing. Thus, the bearing is cooled by the cathode gas.

The bearings become hot during operation of the air compressor 60 due to the rotation of the motor 63. When the rotating shaft 63s and the bearings are welded together, the properties of the air compressor 60 change. Therefore, even when the control device 90 performs the control with reference to the predetermined intake pipe pressure loss map and the exhaust pipe pressure loss map, a situation may occur in which the flow rate of the cathode gas deviates from an ideal value. The intake pipe pressure loss map and the exhaust pipe pressure loss map will be described later. The fuel cell system 1 of the present embodiment cools the bearing by flowing cathode gas to the bearing of the air compressor 60. Therefore, the fuel cell system 1 according to the present embodiment can more accurately determine the pressure-loss in the intake pipe Li and the exhaust pipe Lo than in the embodiment in which the bearings are not cooled. In the present specification, the flow rate flowing through the bearing is defined as the bearing cooling flow rate Qb. The pressure loss in the bearing part is defined as the bearing pressure loss Dtb.

The bearing intake pipe 65 allows a part of the cathode gas discharged from the air compressor 60 to flow to the bearing of the air compressor 60. More specifically, the bearing intake pipe 65 is a pipe connected to the bearing portion of the first stack intake unit 41 and the air compressor 60. In this specification, the pressure loss in the bearing intake pipe 65 is defined as the bearing intake pipe pressure loss Dtbi.

The bearing exhaust pipe 66 allows the cathode gas flowing through the bearing to flow through the system exhaust unit 20. More specifically, the bearing exhaust pipe 66 is a pipe connected to the bearing portion of the air compressor 60 and the system exhaust unit 20. In this specification, the pressure loss in the bearing exhaust pipe 66 is defined as the bearing exhaust pipe pressure loss Dtbo.

The stack intake unit 40 allows the cathode gas discharged from the air compressor 60 to flow through the fuel cell stack 30. The stack intake unit 40 includes a first stack intake unit 41, a second stack intake unit 42, and a third stack intake unit 43.

The first stack intake unit 41 is a pipe connecting the second compressor 62 and the intercooler 150 (see the lower center portion in FIG. 1). The first stack intake unit 41 is also connected to the bearing intake pipe 65. Therefore, a part of the cathode gas discharged from the air compressor 60 flows to the bearing intake pipe 65. The second stack intake unit 42 is a pipe connecting the intercooler 150 and the first valve 110 (see the middle portion of FIG. 1). The second stack intake unit 42 is also connected to the bypass pipe 140 in which the third valve 130 is provided. Therefore, depending on the open/close state of the first valve 110 and the third valve 130, the cathode gas of the second stack intake unit 42 flows to the bypass pipe 140. The third stack intake unit 43 is a pipe connecting the first valve 110 and the cathode flow path 31 (see the upper center portion in FIG. 1).

The intercooler 150 cools the cathode gas discharged from the air compressor 60 (see the middle portion of FIG. 1). The temperature of the cathode gas is increased by being compressed by the air compressor 60. The high-temperature cathode gas, for example, dries the electrolyte membrane of the fuel cell stack 30 and thus promotes deterioration of the fuel cell stack 30. The intercooler 150 cools the cathode gas from coolant supplied from a cooling system (not shown). The intercooler 150 cools the cathode gas under the control of the control device 90 based on the temperature of the cathode gas acquired by the first temperature sensor 160 to the third temperature sensor 180.

The second temperature sensor 170 acquires the temperature of the cathode gas discharged from the intercooler 150 (see the middle part of FIG. 1). The second temperature sensor 170 sends the acquired temperature to the control device 90.

The pressure sensor 80 acquires an outlet pressure Pco which is a pressure at the outlet of the air compressor 60 (see the middle part of FIG. 1). The pressure sensor 80 is provided in the second stack intake unit 42. That is, the pressure sensor 80 is provided downstream of the intercooler 150 and upstream of the first valve 110 and the third valve 130. That is, the pressure sensor 80 acquires the pressure of the cathode gas cooled by the intercooler 150 as the outlet pressure Pco. The pressure sensor 80 sends the acquired outlet pressure Pco to the control device 90.

The first valve 110 is provided on the inlet side of the fuel cell stack 30, and changes the flow rate of the cathode gas supplied to the fuel cell stack 30 (see the middle part of FIG. 1). More specifically, the first valve 110 is provided downstream of the intercooler 150 and upstream of the cathode flow path 31. The first valve 110 opens and closes the valve in response to an instruction from the control device 90. The first valve 110 is also referred to as a sealing valve 110.

An exhaust pipe Lo is connected to the system exhaust unit 20 (see a right portion in FIG. 1). The system exhaust unit 20 includes a first system exhaust unit 21 and a second system exhaust unit 22. The first system exhaust unit 21 is a pipe connecting the cathode flow path 31 and the second valve 120. The second system exhaust unit 22 is a pipe connecting the second valve 120 and the exhaust pipe Lo. That is, the system intake unit 10 causes the cathode gas discharged from the cathode flow path 31 to flow through the exhaust pipe Lo. The second system exhaust unit 22 is also connected to the bypass pipe 140. Therefore, the cathode gas discharged from the bypass pipe 140 flows to the exhaust pipe Lo via the second-system exhaust unit 22.

The third temperature sensor 180 acquires the temperature of the cathode gas discharged from the cathode flow path 31 (see the upper right part in FIG. 1). The third temperature sensor 180 sends the acquired temperature to the control device 90.

The second valve 120 is provided on the outlet side of the fuel cell stack 30, and changes the flow rate of the cathode gas discharged from the fuel cell stack 30 (see the right part of the middle stage in FIG. 1). The second valve 120 is provided in the system exhaust unit 20. The second valve 120 opens and closes the valve in response to an instruction from the control device 90. The second valve 120 is also referred to as a pressure regulating valve 120.

The bypass pipe 140 connects the inlet side of the first valve 110 and the outlet side of the second valve 120. More specifically, the bypass pipe 140 is a pipe connecting the second stack intake unit 42 and the second system exhaust unit 22.

The third valve 130 changes the flow rate of the cathode gas flowing through the bypass pipe 140. That is, the third valve 130 is provided in the bypass pipe 140. The third valve 130 opens and closes the valve in response to an instruction from the control device 90. The third valve 130 is also referred to as a diverter valve 130.

In this specification, the total pressure loss of the system intake unit 10, the stack intake unit 40, the system exhaust unit 20, and the cathode flow path 31 is defined as a system pressure loss Dtf as a pressure loss of the fuel cell system 1.

FIG. 3 is a block diagram illustrating a configuration of the control device 90. The control device 90 is configured as a logic circuit centered on a microcomputer. More specifically, the control device 90 includes a CPU 91, a ROM 92, and a RAM 93. CPU 91 executes a preset control program. ROM 92 stores in advance control programs, control data, and the like required for executing various arithmetic processes in CPU 91. RAM 93 temporarily reads and writes various types of data required for performing various types of arithmetic operations in CPU 91. The function of the control device 90 will be described below.

A-2. To set up a fuel cell system:

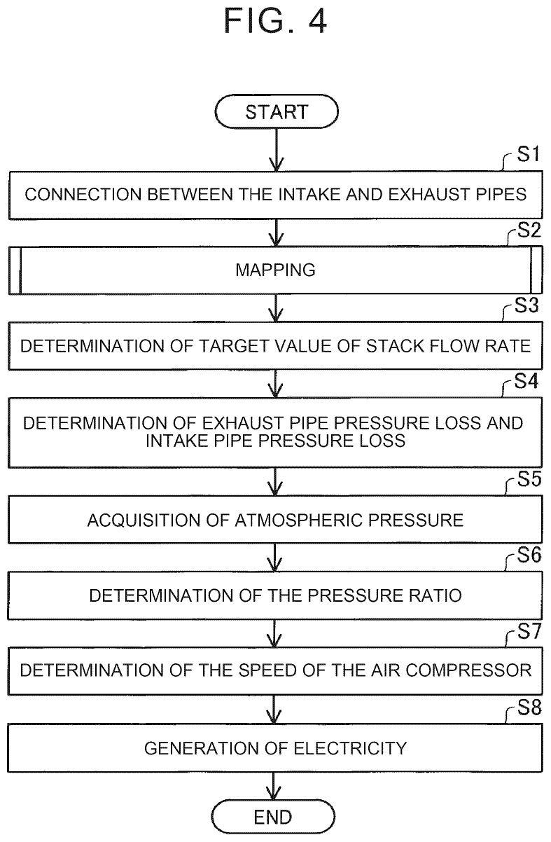

FIG. 4 is a flowchart illustrating a setting method of the fuel cell system 1. A setting method until power generation by the fuel cell system 1 is performed will be described. As described above, the fuel cell system 1 is mounted on a passenger car, a truck, a ship, a stationary power generation facility, or the like.

In S1 of FIG. 4, the fuel cell system 1 is connected to an intake pipe Li and an exhaust pipe Lo of the product to be mounted. Specifically, a user connects the intake pipe Li to the system intake unit 10 and the exhaust pipe Lo to the system exhaust unit 20. The user also attaches the atmospheric pressure sensor 50, the airflow meter 70, the air cleaner 100, and the first temperature sensor 160.

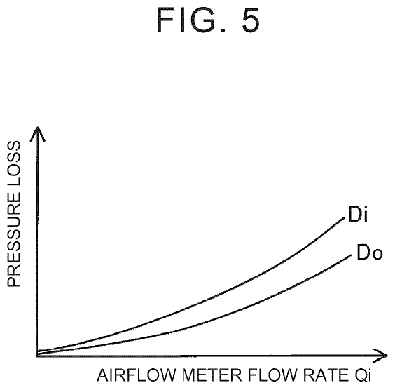

FIG. 5 is an explanatory diagram illustrating a pressure loss map. In S2 of FIG. 4, the control device 90 creates a pressure-loss map. Specifically, the pressure loss map is information illustrated in FIG. 5. The pressure loss map is a generic term of an intake pipe pressure loss map and an exhaust pipe pressure loss map. The intake pipe pressure loss map represents a relation between the airflow meter flow rate Qi and the intake pipe pressure loss Di. The exhaust pipe pressure loss map represents a relation between the airflow meter flow rate Qi and the exhaust pipe pressure loss Do. The creation of the pressure loss map will be described in detail later.

Further, in S2 of FIG. 4, the control device 90 creates a flow rate map of the stack flow rate Qs and the airflow meter flow rate Qi. The flow rate map will also be described in detail below.

In S3 of FIG. 4, the control device 90 determines a target value Qst of the stack flow rate Qs. The control device 90 determines a target current to be output by the fuel cell stack 30 with respect to the electric power required by the load of the fuel cell system 1 for power generation of the fuel cell system 1. The control device 90 determines the target value Qst based on, for example, a predetermined stack flow rate Qs for realizing the target current.

In S4 of FIG. 4, the control device 90 determines the exhaust pipe pressure loss Do and the intake pipe pressure loss Di at the target value Qst by referring to the exhaust pipe pressure loss map and the intake pipe pressure loss map shown in FIG. 5 based on the target value Qst of the stack flow rate Qs and the flow rate map.

More specifically, the control device 90 refers to the flow rate map based on the target value Qst of the stack flow rate Qs, and determines the airflow meter flow rate Qi in the target value Qst. Further, the control device 90 refers to the exhaust pipe pressure loss map and the intake pipe pressure loss map based on the airflow meter flow rate Qi at the target value Qst, and determines the exhaust pipe pressure loss Do and the intake pipe pressure loss Di at the target value Qst.

In S5 of FIG. 4, the control device 90 acquires the atmospheric pressure Pa by the atmospheric pressure sensor 50.

In S6 of FIG. 4, the control device 90 determines the pressure-ratio R of the air compressor 60. The control device 90 determines the inlet pressure Pci based on the difference in the intake pipe pressure loss Di between the atmospheric pressure Pa and the target value Qst of the stack flow rate Qs. The control device 90 determines the outlet pressure Pco based on the sum of the atmospheric pressure Pa and the exhaust pipe pressure loss Do at the target value Qst of the stack flow rate Qs. That is, the pressure ratio R is obtained by Equation (2).

$$R = Pco / Pci = ( Pa + Do ) / ( Pa - Di ) \qquad ( 2 )$$

In S7 of FIG. 4, the control device 90 determines the rotational speed n of the air compressor 60. More specifically, the control device 90 determines the rotational speed n by referring to the characteristic of the air compressor 60 illustrated in FIG. 2 based on the airflow meter flow rate Qi and the pressure ratio R in the target value Qst. That is, the control device 90 determines the rotational speed n for achieving the target value Qst based on the properties of the air compressor 60 and the pressure-ratio R. The information on the characteristics of the air compressor 60 is determined in advance, for example, at the time of manufacturing the fuel cell system 1, and is stored in the control device 90.

In S8 of FIG. 4, the control device 90 performs power generation. That is, the control device 90 controls the air compressor 60 according to the rotational speed n determined to realize the target-value Qst. As a result, the cathode gases satisfying the target value Qst are supplied to the fuel cell stack 30. Further, the fuel cell stack 30 can generate electric power by supplying the anode gas for realizing the target current to the fuel cell stack 30.

That is, in the power generation of the fuel cell system 1, the control device 90 refers to the exhaust pipe pressure loss map and the intake pipe pressure loss map based on the target value Qst of the stack flow rate Qs for realizing the target current, and determines the exhaust pipe pressure loss Do at the target value Qst and the intake pipe pressure loss Di at the target value Qst. In the following, how to create a map including a pressure-loss map of S2 of FIG. 4 will be described.

### A-3. To Create a Pressure-Loss Map:

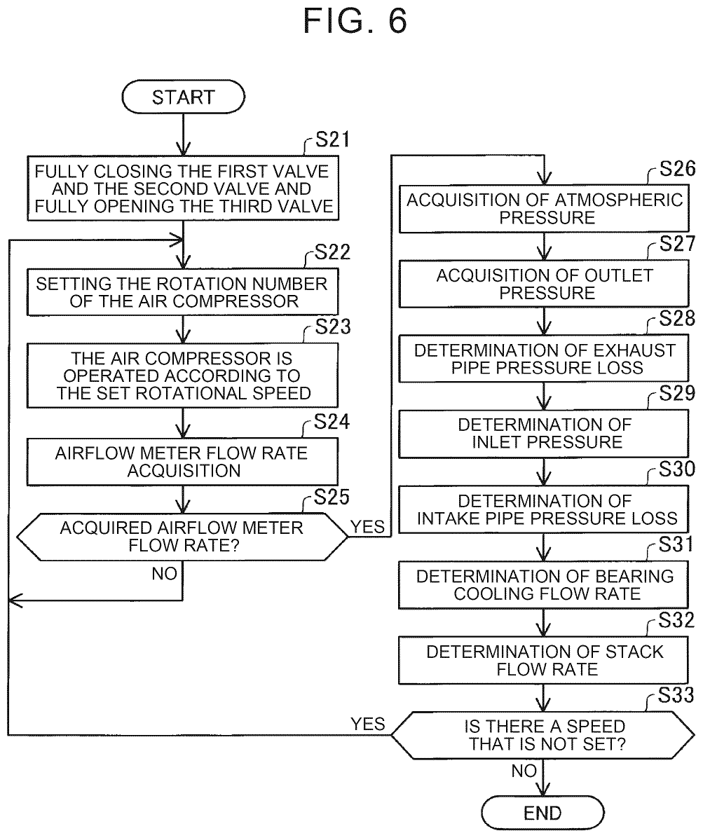

FIG. 6 is a flowchart illustrating a map creation method. In S21 of FIG. 6, the control device 90 fully closes the first valve 110 and the second valve 120. Further, the control device 90 fully opens the third valve 130. That is, the control device 90 does not allow the cathode gas discharged from the air compressor 60 to flow through the fuel cell stack 30. The control device 90 causes the cathode gas discharged from the air compressor 60 to flow to the system exhaust unit 20 via the bypass pipe 140 and the bearing exhaust pipe 66.

With this configuration, when determining the intake pipe pressure loss map and the exhaust pipe pressure loss map, the cathode gas does not flow to the fuel cell stack 30. That is, the fuel cell system 1 of the present embodiment can more accurately determine the pressure loss in the intake pipe Li and the exhaust pipe Lo by removing the pressure loss caused by the fuel cell stack 30.

In S22 to S25 of FIG. 6, the control device 90 determines the pressure loss according to the airflow meter flow rate Qi by changing the rotational speed n of the air compressor 60. For example, the control device 90 sets the rotational speed n of the air compressor 60 based on a plurality of airflow meter flow rate Qi differing from each other. For example, the control device 90 increases the rotational speed n from the smallest rotational speed to the largest rotational speed of the air compressor 60, and advances the process to S26 for each flow rate. In the following, the details of the processing will be described for each step.

In S22 of FIG. 6, the control device 90 sets the rotational speed n of the air compressor 60. For example, when S22 is executed for the first time, the control device 90 sets the rotational speed n to the smallest rotational speed of the air compressor 60. In the second and subsequent S22, the control device 90 sets the rotational speed n of the air compressor 60 to a rotational speed larger than the previous rotational speed.

In S23 of FIG. 6, the control device 90 operates the air compressor 60 according to the set rotational speed. Accordingly, the cathode gas is sucked into the fuel cell system 1.

In S24 of FIG. 6, the control device 90 acquires the airflow meter flow rate Qi by the airflow meter 70.

In S25 of FIG. 6, the control device 90 determines whether or not the airflow meter flow rate Qi has been acquired. When the acquired airflow meter flow rate Qi is already acquired, the control device 90 returns the process to S22. Thus, the control device 90 changes the rotational speed n so that the flow rate Qi of the airflow meter differs. If the acquired airflow meter flow rate Qi is not already acquired, the control device 90 advances the process to S26.

The process of S26 of FIG. 6 is the same as the process of S5 of FIG. 4.

In the process of S27 of FIG. 6, the control device 90 acquires the outlet pressure Pco by the pressure sensor 80.

In S28 of FIG. 6, the control device 90 determines an exhaust pipe pressure loss Do corresponding to the airflow meter flow rate Qi based on the difference between the atmospheric pressure Pa and the outlet pressure Pco. That is, the exhaust-pipe pressure-loss Do is obtained from Equation (3).

$$Do = Pa - Pco \qquad ( 3 )$$

In S29 of FIG. 6, the control device 90 determines the inlet pressure Pci based on the outlet pressure Pco and the rotational speed n of the air compressor 60. More specifically, the control device 90 determines the pressure ratio R according to the flow rate Qi of the airflow meter and the rotational speed n on the basis of the information representing the characteristic of the air compressor 60 in FIG. 3. Based on the determined pressure ratio R and the outlet pressure Pco, the control device 90 determines the calculated inlet pressure Pci from Equation (1).

In S30 of FIG. 6, the control device 90 determines an intake pipe pressure loss Di corresponding to the airflow meter flow rate Qi based on the difference between the calculated inlet pressure Pci and the atmospheric pressure Pa. That is, the intake pipe pressure-loss Di is obtained from Equation (4) based on Equation (2).

$$Di = Pa - Pci = Pa - ( Pa + Do ) / R \qquad ( 4 )$$

In S31 of FIG. 6, the control device 90 determines the bearing cooling flow rate Qb from Equation (5). As described above, the pressure loss of the bearing intake pipe 65 is defined as Dtbi, the pressure loss of the bearing exhaust pipe 66 is defined as Dtbo, the pressure loss of the bearing part in the motor 63 is defined as Dtb, and the pressure loss of the exhaust pipe Lo is defined as Do. The total pressure loss of the fuel cell system 1 of the system intake unit 10, the stack intake unit 40, the system exhaust unit 20, and the cathode flow path 31 is defined as Dtf.

$$Qb = ( ( Dtbi + Dtbo + Dtb + Do ) / ( Dtf + Do ) ) \times Q i \qquad ( 5 )$$

The bearing intake pipe pressure loss Dtbi, the bearing exhaust pipe pressure loss Dtbo, the bearing pressure loss Dtb, and the system pressure loss Dtf are determined in advance at the time of manufacturing the fuel cell system 1, for example, and are stored in the control device 90.

In S32 of FIG. 6, the control device 90 determines the stack flow rate Qs. The control device 90 determines the stack flow rate Qs from Equation (6) because the sum of the bearing cooling flow rate Qb and the stack flow rate Qs is the airflow meter flow rate Qi.

$$Qs = Qi - Qb \qquad ( 6 )$$

In S33 of FIG. 6, the control device 90 determines whether or not there is an unset rotational speed at the rotational speed n of the air compressor 60. If there is a rotational speed that has not been set, the control device 90 returns the process to S22. The control device 90 ends the process when there is no set rotational speed. For example, the control device 90 repeats the process while increasing the rotational speed n of the air compressor 60 from the minimum rotational speed to the maximum rotational speed. When the rotational speed n reaches the maximum rotational speed, the control device 90 ends the process.

As described above, the control device 90 creates various maps by determining the exhaust pipe pressure loss Do, the intake pipe pressure loss Di, and the stack flow rate Qs according to the airflow meter flow rate Qi.

That is, the control device 90 creates a pressure-loss map while changing the airflow meter flow rate Qi while closing the first valve 110 and the second valve 120 and opening the third valve 130. Specifically, the control device 90 creates an exhaust pipe pressure loss map corresponding to the airflow meter flow rate Qi based on the difference between the atmospheric pressure Pa and the outlet pressure Pco. The control device 90 creates an intake pipe pressure loss map according to the airflow meter flow rate Qi based on the difference between the calculated inlet pressure Pci and the atmospheric pressure Pa.

Further, the control device 90 creates a flow rate map while changing the airflow meter flow rate Qi. Specifically, the control device 90 creates a flow rate map of the stack flow rate Qs corresponding to the airflow meter flow rate Qi on the basis of the intake pipe pressure loss Di, the exhaust pipe pressure loss Do, the bearing exhaust pipe pressure loss Dtbo, the bearing intake pipe pressure loss Dtbi, and the system pressure loss Dtf.

As described above, the fuel cell system 1 of the present embodiment controls the flow rate of the cathode gas in accordance with the product mounted on the fuel cell system 1. The fuel cell system 1 of the present embodiment is mounted on various products such as a passenger car, a truck, a ship, and a stationary power generation facility. The pressure-loss of the intake pipe Li and the exhaust pipe Lo varies depending on the components mounted on the fuel cell system 1. With this configuration, the fuel cell system 1 of the present embodiment determines the intake pipe pressure loss map and the exhaust pipe pressure loss map before power generation is performed. Accordingly, the fuel cell system 1 of the present embodiment can control the rotational speed n of the air compressor 60 by considering the pressure-loss of the intake pipe Li and the exhaust pipe Lo during power generation. Therefore, the fuel cell system 1 according to the present embodiment can accurately control the flow rate of the cathode gas supplied to the fuel cell stack 30 as compared with a configuration in which a fixed pressure-loss is used regardless of the specifications of the intake pipe Li and the exhaust pipe Lo.

Further, the fuel cell system 1 of the present embodiment creates a pressure loss map in a state in which the first valve 110 and the second valve 120 are closed and the third valve 130 is opened. With this configuration, since the intake pipe pressure loss map and the exhaust pipe pressure loss map are determined as described above, the cathode gas does not flow into the fuel cell stack 30 when the cathode gas is flowing into the fuel cell system 1. That is, the fuel cell system 1 of the present embodiment can more accurately determine the pressure loss in the intake pipe Li and the exhaust pipe Lo by removing the pressure loss caused by the fuel cell stack 30.

Moreover, in the fuel cell system 1 of the present embodiment, as described above, the cathode gas is caused to flow through the bearing of the air compressor 60. The bearings of the air compressor 60 become hot due to the rotation of the motor 63 during the operation of the air compressor 60. As a result, the characteristics of the air compressor 60 change due to welding of the shaft and the bearing. Therefore, even if the control device 90 performs control with reference to the predetermined intake pipe pressure loss map and exhaust pipe pressure loss map, a situation may occur in which the flow rate of the cathode gas deviates from an ideal value. The fuel cell system 1 of the present embodiment cools the bearing by causing the cathode gas to flow through the bearing of the air compressor 60. Therefore, in the fuel cell system 1 of the present disclosure, the flow rate of the cathode gas flowing through the fuel cell stack 30 can be controlled more accurately than in the form in which the bearing is not cooled.

The cathode gas flowing through the bearing is a part of the cathode gas discharged from the air compressor 60. Thus, the stack flow rate Qs is lower than the airflow meter flow rate Qi. That is, since the stack flow rate Qs is not regarded as the airflow meter flow rate Qi, based only on the target value Qst of the stack flow rate Qs to be supplied to the fuel cell stack 30, the accurate exhaust pipe pressure loss Do and the intake pipe pressure loss Di cannot be determined. Further, the flow rate of the cathode gases flowing through the bearings varies depending on the exhaust pipe pressure loss Do and the intake pipe pressure loss Di. For example, depending on the size of the exhaust pipe pressure loss Do, the pressure of the system exhaust unit 20 increases, and the cathode gases are less likely to flow into the bearings. In other words, the difference between the intake pipe Li and the exhaust pipe Lo affects the temperature of the bearings. Therefore, prior to power generation, the fuel cell system 1 of the present embodiment creates a flow rate map representing the airflow meter flow rate Qi corresponding to the stack flow rate Qs based on the pressure loss of the intake pipe Li, the exhaust pipe Lo, and the like. Accordingly, in the power generation, the fuel cell system 1 of the present disclosure can accurately control the flow rate of the cathode gas flowing through the fuel cell stack 30 by considering the flow rate of the cathode gas flowing through the bearings based on the target value Qst of the stack flow rate Qs and the flow rate map.

### B. Other Embodiments

(1) In the above embodiment, the fuel cell system 1 performs the determination of the intake pipe pressure loss map and the intake pipe pressure loss map in a state in which the first valve 110 and the second valve 120 are closed and the third valve 130 is opened. However, the fuel cell system 1 may determine the intake pipe pressure loss map and the intake pipe pressure loss map in a state where the first valve 110 and the second valve 120 are opened and the third valve 130 is closed. Alternatively, the fuel cell system 1 may not include the first valve 110 to the third valve 130 and the bypass pipe 140. That is, the fuel cell system 1 may create a pressure loss map in a state in which the cathode gas is caused to flow through the cathode flow path 31. With such a configuration, the fuel cell system 1 can be more easily controlled than controlling the first valve 110 to the third valve 130.
(2) In the above embodiment, the air compressor 60 includes a bearing intake pipe 65 and a bearing exhaust pipe 66. However, the air compressor 60 may not include the bearing intake pipe 65 and the bearing exhaust pipe 66. In such a configuration, the fuel cell system 1 can supply all of the cathode gas discharged from the air compressor 60 to the fuel cell stack 30. That is, the airflow meter flow rate Qi is considered a stack flow rate Qs.

Therefore, the control device 90 may determine the exhaust pipe pressure loss Do and the intake pipe pressure loss Di at the target value Qst by referring to the exhaust pipe pressure loss map and the intake pipe pressure loss map only based on the target value Qst of the stack flow rate Qs. In the first embodiment, the control device 90 determines the exhaust pipe pressure loss Do and the intake pipe pressure loss Di at the target value Qst based on the target value Qst of the stack flow rate Qs and the flow rate map. However, in such a configuration, since the flow rate map is not used, it is not necessary to create the flow rate map. Therefore, the fuel cell system 1 can easily configure the air compressor 60. Furthermore, the fuel cell system 1 can be easily controlled.
(3) In the above-described embodiment, the air compressor 60 is a two-stage boost type turbocompressor. However, the air compressor 60 may be a one-stage boost turbocompressor.
(4) In the above-described embodiment, the components of the fuel cell system 1 other than the atmospheric pressure sensor 50, the airflow meter 70, the air cleaner 100, and the first temperature sensor 160 are configured as a single module M1 regardless of the positions of the intake pipe Li and the exhaust pipe Lo. However, the fuel cell system 1 may not constitute a single module M1, or a single module M1 may be formed by combining components that differ from the above-described embodiments.
(5) In the above-described embodiment, the pressure obtained by the atmospheric pressure sensor 50 is used for the atmospheric pressure Pa. However, the atmospheric pressure Pa may be a predetermined value. For example, the atmospheric pressure Pa may be a normal atmospheric pressure.
(6) In the above-described embodiment, the airflow meter 70 is provided in the second intake pipe Li2, but may be provided in the first intake pipe Li1.
(7) In the above-described embodiment, the control device 90 controls the stack flow rate Qs by the air compressor 60. However, the control device 90 may also use the third valve 130 to control the stack flow rate Qs. For example, the control device 90 may determine the stack flow rate Qs according to Equation (7) based on a predetermined relation between the degree of opening and closing of the third valve 130 and the flow rate of the cathode gas flowing through the third valve 130. The flow rate of the cathode gas flowing through the third valve 130 is defined as the by-pass flow rate Qd.

$$Qs = Qi - Qb - Qd \qquad ( 7 )$$

(8) In S22 to S25 of FIG. 6 in the above embodiment, the control device 90 increases the rotational speed n from the smallest rotational speed to the largest rotational speed of the air compressor 60, and advances the process to S26 for each flow rate. However, other methods may be used for the method of setting the rotational speed n. For example, the control device 90 may set the number of revolutions n within a range of a predetermined number of revolutions regardless of the minimum number of revolutions or the maximum number of revolutions of the air compressor 60.

The present disclosure is not limited to the above-described embodiments, and can be realized with various configurations without departing from the spirit thereof. For example, the technical features of the embodiments corresponding to the technical features in the respective embodiments described in the summary of the disclosure can be appropriately replaced or combined in order to solve some or all of the above-described problems or to achieve some or all of the above-described effects. When the technical 10 features are not described as essential in this specification, the technical features can be deleted as appropriate.

What is claimed is:

1. A fuel cell system comprising:
a system intake unit through which cathode gas to be supplied to the fuel cell system flows and to which an intake pipe having an intake pipe pressure loss is connected;
a system exhaust unit through which the cathode gas discharged from the fuel cell system flows and to which an exhaust pipe having an exhaust pipe pressure loss is connected;
a fuel cell stack configured to generate electric power using the cathode gas supplied via the system intake unit and discharge the cathode gas used for power generation via the system exhaust unit;
an atmospheric pressure sensor configured to acquire an atmospheric pressure;
an air compressor configured to compress the cathode gas flowing through the system intake unit and discharge the cathode gas to the fuel cell stack;
an airflow meter configured to acquire an airflow meter flow rate that is a flow rate of the cathode gas to be sucked into the air compressor;
a pressure sensor configured to acquire an outlet pressure that is a pressure on an outlet side of the air compressor; and
a control device configured to control the fuel cell system, wherein the control device is configured to:
prior to the power generation in the fuel cell system, operate the air compressor at a plurality of different airflow meter flow rates in a state in which the intake pipe and the exhaust pipe are connected to the fuel cell system;
create an exhaust pipe pressure loss map associated with the airflow meter flow rate based on a difference between the atmospheric pressure as a pressure of the cathode gas at an outlet of the exhaust pipe and the outlet pressure;
create an intake pipe pressure loss map associated with the airflow meter flow rate based on a difference between a calculated value of an inlet pressure that is a pressure on an inlet side of the air compressor and determined based on the outlet pressure and a rotation speed of the air compressor and the atmospheric pressure as a pressure of the cathode gas at an inlet of the intake pipe;
in the power generation in the fuel cell system,
determine, based on a target value of a stack flow rate of supply to the fuel cell stack for realizing a target current, the exhaust pipe pressure loss at the target value and the intake pipe pressure loss at the target value by referring to the exhaust pipe pressure loss map and the intake pipe pressure loss map; and
determine a rotation speed for realizing the target value at a pressure ratio between the inlet pressure determined based on a difference between the atmospheric pressure and the intake pipe pressure loss at the target value and the outlet pressure determined based on a sum of the atmospheric pressure and the exhaust pipe pressure loss at the target value, and control the air compressor based on the determined rotation speed.

2. The fuel cell system according to claim 1, further comprising:
a first valve provided on an inlet side of the fuel cell stack and configured to change the flow rate of the cathode gas to be supplied to the fuel cell stack;
a second valve provided on an outlet side of the fuel cell stack and configured to change the flow rate of the cathode gas discharged from the fuel cell stack;
a bypass pipe connecting an inlet side of the first valve and an outlet side of the second valve; and
a third valve configured to change the flow rate of the cathode gas flowing through the bypass pipe, wherein
the control device is configured to create the intake pipe pressure loss map and the exhaust pipe pressure loss map in a state in which the first valve and the second valve are closed and the third valve is open.

3. The fuel cell system according to claim 2, wherein:
the air compressor further includes
a bearing intake pipe through which part of the cathode gas discharged by the air compressor flows to a bearing of the air compressor and that has a bearing intake pipe pressure loss as a pressure loss, and
a bearing exhaust pipe through which the cathode gas having flowed through the bearing flows to the system exhaust unit and that has a bearing exhaust pipe pressure loss as the pressure loss; and
the control device is configured to
prior to the power generation in the fuel cell system and in a state in which the air compressor is operating, create a flow rate map of the stack flow rate associated with the airflow meter flow rate based on the intake pipe pressure loss, the exhaust pipe pressure loss, the bearing exhaust pipe pressure loss, the bearing intake pipe pressure loss, and a pressure loss of the fuel cell system, and
in the power generation in the fuel cell system, determine the exhaust pipe pressure loss and the intake pipe pressure loss based on the target value and the flow rate map.
